(19) United States
(12) Patent Application Publication
(10) Pub. No.: US 2025/0294565 A1
(43) Pub. Date: Sep. 18, 2025

(54) PUSCH ENHANCEMENTS FOR RADAR COEXISTENCE

(71) Applicant: INTERDIGITAL PATENT HOLDINGS, INC., Wilmington (DE)

(72) Inventors: Joe Huang, Montville, NJ (US); Sudhir Pattar, Mount Laurel, NJ (US); Philip Pietraski, Jericho, NY (US); Tariq Elkourdi, Belleville, NJ (US); Jane Mack, Melville, NY (US); Daniel Steinbach, Commack, NY (US); Phillip Leithead, King of Prussia, PA (US)

(73) Assignee: INTERDIGITAL PATENT HOLDINGS, INC., Wilmington (DE)

(21) Appl. No.: 18/861,375

(22) PCT Filed: Apr. 28, 2023
(86) PCT No.: PCT/US2023/020403

§ 371 Date: Oct. 29, 2024

Related U.S. Application Data
(60) Provisional application No. 63/336,899, filed on Apr. 29, 2022.

(51) Int. Cl. H04W 72/21; H04B 7/0456; H04L 1/1812

(52) U.S. Cl. CPC H04W 72/21; H04B 7/0456; H04L 1/1812

(57) ABSTRACT

A wireless transmit receive unit (WTRU) and methods are disclosed for mitigating radar interference on PUSCH transmission. The method may include: transmitting a message informing a network of PUSCH MIMO layer aggregation capability; receiving a MIMO rank; receiving an indication to use PUSCH MIMO layer aggregation; determining a PUSCH layer aggregation level based on the MIMO rank; and transmitting multiple redundancy versions of a PUSCH codeword comprising one or more code blocks based on the PUSCH layer aggregation level. The WTRU may be configured to transmit a message informing a network of PUSCH MIMO layer aggregation capability; receive a MIMO rank; receive an indication to use PUSCH MIMO layer aggregation; determine a PUSCH layer aggregation level based on the MIMO rank; and transmit multiple redundancy versions of a PUSCH codeword comprising one or more code blocks based on the PUSCH layer aggregation level.

### CROSS-REFERENCE TO RELATED APPLICATIONS

This application claims the benefit of U.S. Provisional Application No. 63/336,899, filed Apr. 29, 2022, the contents of which are incorporated herein by reference.

### STATEMENT OF GOVERNMENT RIGHTS

This invention was made with government support under project NSC-20-2084: Dynamic Spectrum Sharing 5G networks enhancement prototype, also known as ENhanced SecURity and co-Existence for DoD —5G (ENSURED-5G); OTA Number W15QKN-15-9-1004, Base and Project Agreement 2017-314A-Mod-03, Subcontract 2021-01. The government has certain rights in the invention.

### BACKGROUND

Recent trends are driving researchers to create solutions for cellular network deployments in the presence of high-power narrowband interferers (e.g., RADARs). Although the baseline functionality provided by 5G could be used to provide some level of coexistence with RADARs, enhancements will be required to realize the full 5G potential.

When a narrow-band high power interferer such as RADAR operates in a band that overlaps with the RBs used by the WTRU to transmit over PUSCH, the gNB would not be able to reliably receive data radio bearer (DRB) and signaling radio bearer (SRB) traffics on the uplink, as well as uplink HARQ retransmissions. In addition, uplink control information control (UCI) such as HARQ ACK/NACK feedbacks for the downlink transmission and downlink channel state information (CSI) feedbacks may also be transmitted over the PUSCH channel. In cases where the PUSCH can be received reliably in the presence of interference, there is the potential for the PUSCH transmission to interfere with the RADAR system, which is also problematic.

### SUMMARY

Aspects, features and advantages of the disclosed embodiments ensure robust and efficient PUSCH transmission and reception in the presence of RADAR interference. A method implemented by a wireless transmit/receive unit (WTRU) may comprise: transmitting a message informing a network of PUSCH MIMO layer aggregation capability; receiving a MIMO rank; receiving an indication to use PUSCH MIMO layer aggregation; determining a PUSCH layer aggregation level based on the MIMO rank; and transmitting multiple redundancy versions of a PUSCH codeword comprising one or more code blocks based on the PUSCH layer aggregation level.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram depicting a potential scenario of a wireless network encountering interference from RADAR;

FIG. 3 is an exemplary configuration for uplink cancellation;

FIG. 4 is an exemplary configuration for PUSCH time domain resource allocation;

FIG. 5 is an exemplary configuration for PUSCH time domain resource allocation;

FIG. 6 is an exemplary configuration for PUSCH aggregation;

FIG. 7 is an exemplary configuration for PUSCH power control;

FIG. 8 shows an exemplary system for sensing RADAR information;

FIG. 9 shows an exemplary PUCSH resource cancellation in the presence of RADAR interference;

FIG. 10A shows an exemplary PUSCH resource cancellation in the presence of RADAR interference;

FIG. 10B shows an exemplary PUSCH resource cancellation in the presence of RADAR interference;

FIG. 10C shows an exemplary PUSCH resource cancellation in the presence of RADAR interference

FIG. 11A shows an exemplary serial mapping of two redundancy versions of a codeword to two MIMO layers;

FIG. 11B shows an exemplary serial mapping of three redundancy versions of a codeword to three MIMO layers;

FIG. 11C shows an exemplary serial mapping of four redundancy versions of a codeword to four MIMO layers;

FIG. 12A shows an exemplary parallel mapping of two redundancy versions of a codeword to two MIMO layers;

FIG. 12B shows an exemplary parallel mapping of three redundancy versions of a codeword to three MIMO layers;

FIG. 12C shows an exemplary parallel mapping of four redundancy versions of a codeword to four MIMO layers;

FIG. 13 is a flow diagram of an exemplary process implemented by a WTRU including PUSCH layer aggregation.

### DETAILED DESCRIPTION

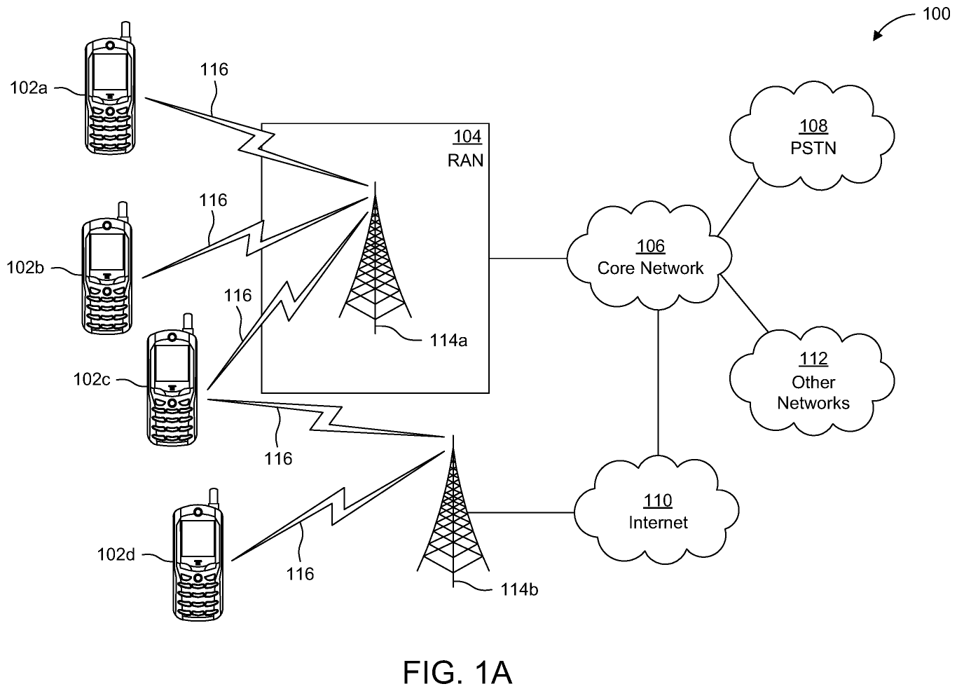

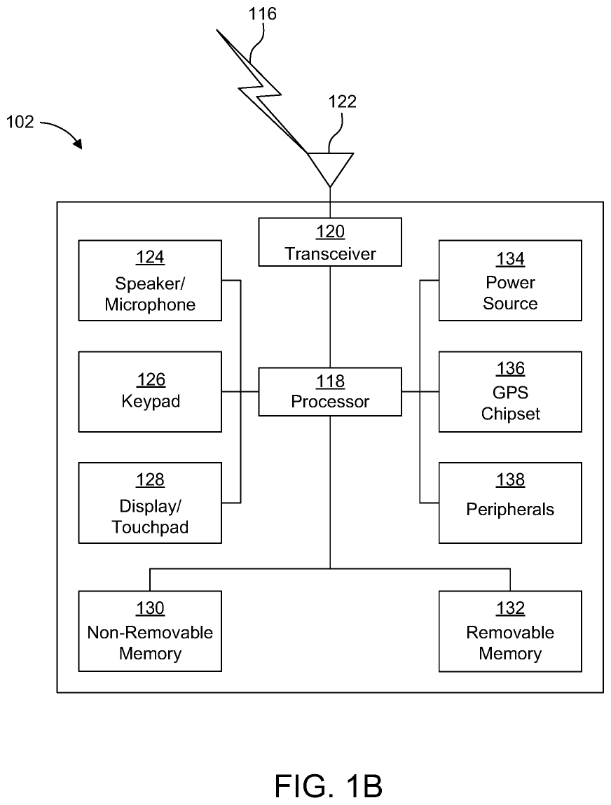

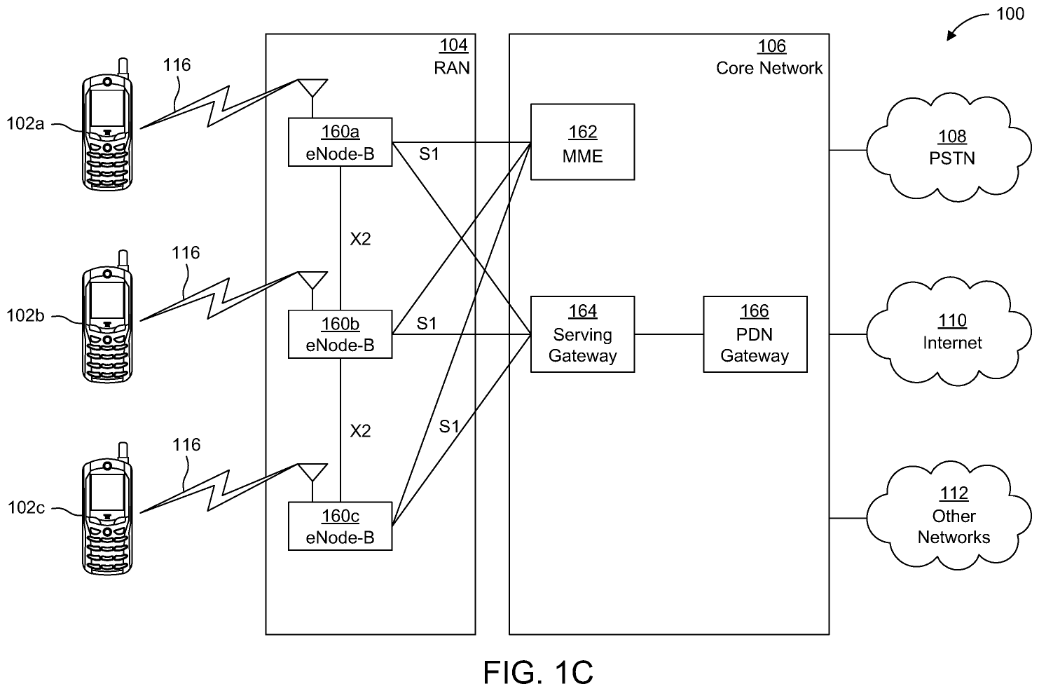

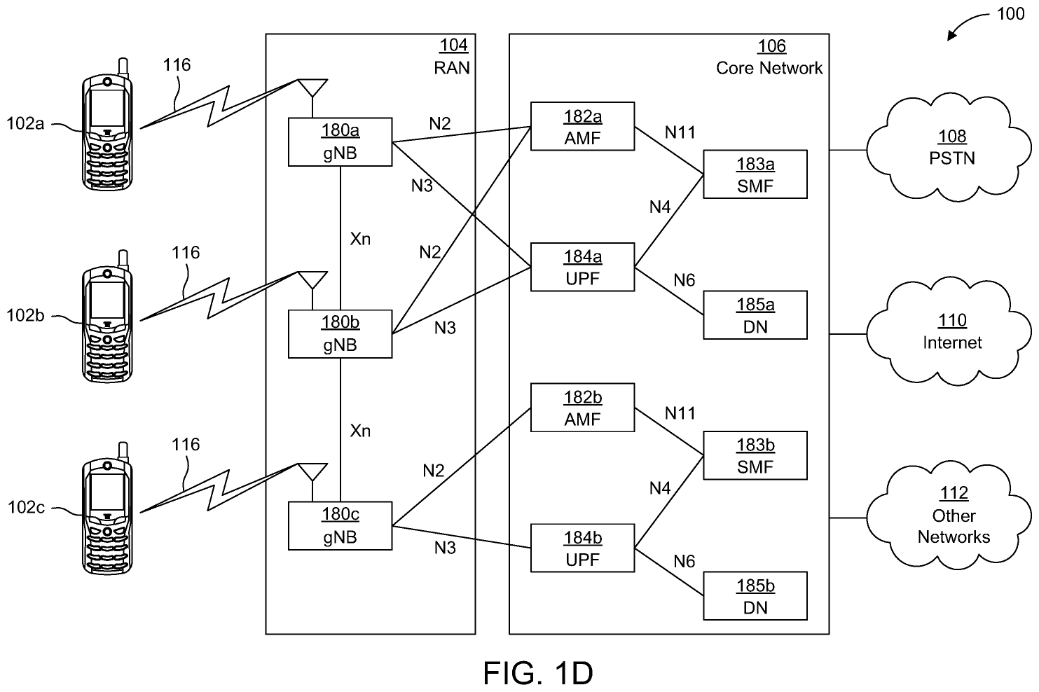

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations may be referred to herein:
3GPP Third Generation Partnership Project
5G 5^{th} Generation
AOA Angle of Arrival
BW Bandwidth
BWP Bandwidth Part
CB Code Block
CBG Code Block Group
CCE Control Channel Element
CI Cancellation Indicator
CORESET Control Resource Set
CRO Cyclic Redundancy Check
C-RNTI Cell Specific Radio Network Temporary Identifier
CI-RNTI Cancellation Indicator Radio Network Temporary Identifier
CS-RNTI Configured Scheduling Radio Network Temporary Identifier
CSI Channel State Information
CSI-RS Channel State Information Reference Signal
DCI Downlink Control Information
DL Downlink
DMRS Demodulation Reference Signal
DRB Data Radio Bearer
ENSURED-5G Enhanced Security and Co-Existence for DoD-5G
gNB Next Generation (5G) NodeB
MAC Medium Access Control
MAC-CEMAC Control Element
MCS Modulation and Coding Scheme
MCS-C-RNTI Modulation and Coding Scheme Cell Specific Radio Network Temporary Identifier
MSB Most Significant Bits
NDI New Data Indicator
NR New Radio
OAM Operations Administration and Maintenance
OFDM Orthogonal Frequency Division Multiplexing
PDCCH Physical Downlink Control Channel
PHY Physical Layer
PRB Physical Resource Block
PSD Power Spectral Density
PUCCH Physical Uplink Control Channel
PUSCH Physical Uplink Shared Channel
QCL Quasi-Collocated
QOS Quality of Service
RACH Random Access Channel
RADAR Radio Detection and Ranging
RB Resource Block
RE Resource Element
REG Resource Element Group
RIV Resource Indication Value
RRC Radio Resource Control
RV Redundancy Version
SINR Signal to Interference plus Noise Ratio
SLIV Start and Length Indicator Value
SRB Signaling Radio Bearer
SRS Sounding Reference Signal
SSB SS/PBCH block
SUL Supplemental Uplink
TB Transport Block
TPMI Transmit Precoder Matrix Indicator
UCI
Uplink Control Information
Uplink
UL
URLLC Ultra Reliable Low Latency Communication

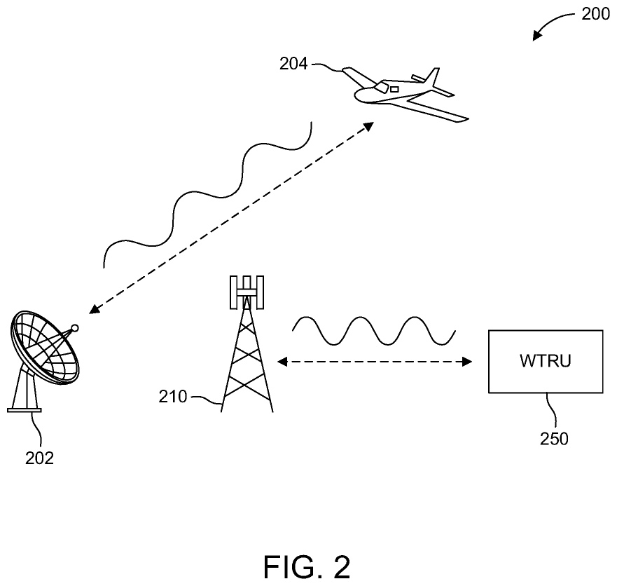

Referring to FIG. 2, an example potential interference scenario 200 is shown where communications between a base station 210 and a remote WTRU 250 may be adversely impacted by the presence of narrowband interferers, such as RADAR station 202 and/or RADAR on plane 204 (or reflections therefrom). The example embodiments that follow, address potential interference avoidance solutions for PUSCH communications between a WTRU 250 and base station 210.

Uplink preemption between WTRUs is described herein. Uplink preemption involves mechanisms for controlling the interference from low-priority traffic to latency-critical high-priority traffic. Two mechanisms are available: 1) Cancellation, where the low-priority transmission is cancelled; 2) Power boosting, where the high priority transmission uses a higher power level than what would be used in the absence of preemption.

The cancellation approach involves the reception of a cancellation indicator, which is transmitted using DCI format 2_4 scrambled with CI-RNTI (Cancellation Indicator RNTI). The cancellation indicator is a bitmap indicating a set of OFDM symbols and resource blocks upon which transmission should be cancelled. Upon reception of a cancellation indicator, a UE should stop transmission of any PUSCH or SRS that (partially) overlaps with any of the cancelled resources.

The cancellation indicator must come a certain minimum time before the start of a PUSCH (or SRS) transmission in order for that transmission to be cancelled. This is needed to allow a WTRU to properly process and account for the cancellation indicator. It also means that an already on-going PUSCH transmission cannot be stopped—with one exception—a PUSCH transmission configured with a repetition factor of two and receiving the cancellation indicator during the first transmission will cancel the second transmission, assuming the WTRU is capable of simultaneous reception and transmission and there is sufficient time for cancelling the repeated PUSCH.

If a WTRU is provided UplinkCancellation, the WTRU is provided, in one or more serving cells, a search space set for monitoring the first PDCCH candidate with a CCE aggregation level of Lc, CCEs of the search space set for detection of a DCI format 2_4 with a CI-RNTI provided by ci-RNTI. UplinkCancellation additionally provides to the WTRU:
a set of serving cells, by ci-ConfigurationPerServingCell, that includes a set of serving cell indexes and a corresponding set of locations for fields in DCI format 2_4 by positioninDCI; a number of fields in DCI format 2_4, by positionInDCI-forSUL, for each serving cell for a SUL carrier, if the serving cell is configured with a SUL carrier; an information payload size for DCI format 2_4 by dci-PayloadSize-ForCI; an indication for time-frequency resources by timeFrequencyRegion.

For a serving cell having an associated field in a DCI format 2_4, for the field is denoted by: N_{CI} a number of bits provided by ci-PayloadSize: B_{CI} a number of PRBs provided by frequencyRegionforCI in timeFrequencyRegion; T_{CI} a number of symbols, excluding symbols for reception of SS/PBCH blocks and DL symbols indicated by tdd-UL-DL-ConfigurationCommon, from a number of symbols that is provided by timeDurationforCI in timeFrequencyRegion, if the PDCCH monitoring periodicity for the search space set with the DCI format 2_4 is one slot and there are more than one PDCCH monitoring occasions in a slot, or is equal to the PDCCH monitoring periodicity, otherwise; and G_{CI} a number of partitions for the T_{CI} symbols provided by timeGranularityforCI in timeFrequencyRegion

G_{CI} sets of bits from the MSB of the N_{CI} bits have a one-to-one mapping with G_{CI} groups of symbols where each of the first G_{CI}−T_{CI}+└T_{CI}/G_{CI}┘·G_{CI} groups includes └T_{CI}/G_{CI}┘ symbols and each of the remaining T_{CI}−└T_{CI}/G_{CI}┘·G_{CI} groups includes └T_{CI}/G_{CI}┘ symbols. A WTRU determines a symbol duration with respect to a SCS configuration of an active DL BWP where the WTRU monitors PDCCH for DCI format 2_4 detection.

For a group of symbols, N_{BI}=N_{CI}/G_{CI} bits from MSB of each set of bits have a one-to-one mapping with N_{BI} groups of PRBs where each of the first N_{BI}−B_{CI}+└B_{CI}/N_{BI}┘·N_{BI} groups includes └B_{CI}/N_{BI}┘ PRBs and each of the remaining B_{CI}−└B_{CI}/N_{BI}┘·N_{BI} groups includes └B_{CI}/N_{BI}┘ PRBs. A WTRU determines a first PRB index as N_{RFR}^{start}=O_{carrier}+RBₛₜₐᵣₜ and a number of contiguous RBs as B_{CI}=L_{RB} from frequencyRegionforCI that indicates an offset RBₛₜₐᵣₜ and a length L_{RB} as RIV, and from offsetToCarrier in FrequencyInfoUL-SIB or FrequencyInfoUL that indicates O_{carrier} for a SCS configuration of an active DL BWP where the WTRU monitors PDCCH for DCI format 2_4 detection.

In uplink resource allocation of type 1, the resource block assignment information indicates to a scheduled UE a set of contiguously allocated non-interleaved virtual resource blocks within the active bandwidth part of size N_{BWP}^{size} PRBs except for the case when DCI format 0_0 is decoded in any common search space in which case the size of the initial UL bandwidth part N_{BWP,O}^{size} shall be used.

An uplink type 1 resource allocation field consists of a resource indication value (RIV) corresponding to a starting virtual resource block (RBₛₜₐᵣₜ) and a length in terms of contiguously allocated resource blocks L_{RBs}. The resource indication value is defined by:

if (L_{RBs} − 1) ≤ └N_{BWP}^{size} / 2┘ then
RIV = N_{BWP}^{size} (L_{RBS} − 1) − RBₛₜₐᵣₜ
else
RIV − N_{BWP}^{size} (N_{BWP}^{size} − L_{RBS} + 1) + (N_{BWP}^{size} − 1 − RBₛₜₐᵣₜ)

where L_{RBS}≥1 and shall not exceed N_{BWP}^{size}−RBₛₜₐᵣₜ.

An indication by a DCI format 2_4 for a serving cell is applicable to a PUSCH transmission or an SRS transmission on the serving cell. If the PUSCH transmission or the SRS transmission is scheduled by a DCI format, the indication by the DCI format 2_4 is applicable to the PUSCH transmission or SRS transmission only if the last symbol of the PDCCH reception providing the DCI format is earlier than the first symbol of the PDCCH reception providing the DCI format 2_4. For the serving cell, the WTRU determines the first symbol of the T_{CI} symbols to be the first symbol that is after T′_{proc,2} from the end of a PDCCH reception where the WTRU detects the DCI format 2_4, where T′_{proc,2} is obtained from T_{proc,2} for PUSCH processing capability 2[TS 38.214] assuming d_{2,1}=d_{offset}·2^{-μUL}/2^{-μ}where d_{offset} is provided by delta_Offset, μ being the smallest SCS configuration between the SCS configuration of the PDCCH and the smallest SCS configuration μ_{UL} provided in scs-SpecificCarrierList of FrequencyInfoUL or FrequencyInfoUL-SIB. The WTRU does not expect to cancel the PUSCH transmission or the SRS transmission before a corresponding symbol that is T_{proc,2} assuming that d_{2,1}=0 after a last symbol of a CORESET where the WTRU detects the DCI format 2_4.

A WTRU that detects a DCI format 2_4 for a serving cell cancels a PUSCH transmission or an actual repetition of a PUSCH transmission if the PUSCH transmission is with repetition Type B, or an SRS transmission on the serving cell if, respectively: the transmission is PUSCH with priority 0, if the WTRU is provided uplinkCancellationPriority, a group of symbols, from the T_{CI} symbols, has at least one bit value of ‘1’ in the corresponding set of N_{BI} bits in the DCI format 2_4 and includes a symbol of the (repetition of the) PUSCH transmission or of the SRS transmission; and a group of PRBs, from the B_{CI} PRBs, has a corresponding bit value of “1” in the set of bits corresponding to the group of symbols in the DCI format 2_4 and includes a PRB of the (repetition of the) PUSCH transmission or of the SRS transmission; where: the cancellation of the (repetition of the) PUSCH transmission includes all symbols from the earliest symbol of the (repetition of the) PUSCH transmission that is in a group of symbols having corresponding bit values of ‘1’ in the DCI format 2_4; and the cancellation of the SRS transmission includes only symbols that are in one or more groups of symbols having corresponding bit values of ‘1’ in the DCI format 2_4.

If, based on an indication by a DCI format 2_4, a WTRU cancels a PUSCH transmission or an SRS transmission, the WTRU does not expect to be scheduled by a second DCI format to transmit a PUSCH or an SRS over symbols that include symbols of the cancelled PUSCH transmission or SRS transmission, where the last symbol of the PDCCH reception providing the second DCI format is later than the first symbol of the PDCCH reception providing the DCI format 2_4.

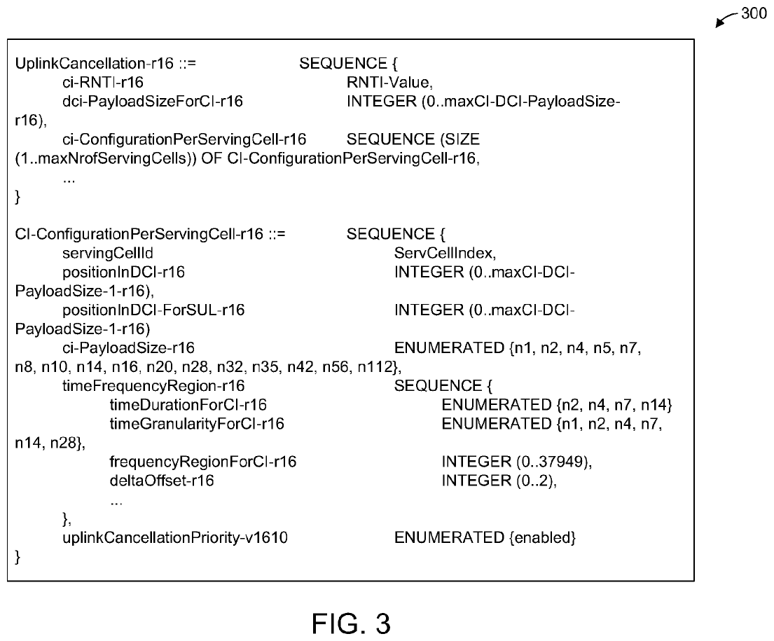

An exemplary uplink cancellation configuration is shown in FIG. 3, 300. Table 1 shows exemplary UplinkCancellation field descriptions. Table 2 shows CI-ConfigurationPerServingCell field descriptions. Table 3 shows conditionally-present terms.

TABLE 1
UplinkCancellation field descriptions

ci-ConfigurationPerServingCell
Indicates (per serving cell) the position of the ci-PaylaodSize
bit CI values inside the DCI payload.
ci-RNTI
RNTI used for indication cancellation in UL.
dci-PayloadSizeForCI
Total length of the DCI payload scrambled with CI-RNTI

TABLE 2
CI-ConfigurationPerServingCell field descriptions

ci-PayloadSize
Configures the field size for each UL cancelation indicator
of this serving cell (servingCellId)
deltaOffset
Configures the additional offset from the end of a PDCCH
reception where the UE detects the DCI format 2_4 and the
first symbol of the T_“CI” symbols, in the unit of OFDM symbols.
frequencyRegionForCI
Configures the reference frequency region where a detected UL
CI is applicable. It is defined in the same way as locationAndBandwidth.
positionInDCI
Starting position (in number of bit) of the ci-PayloadSize
bit CI value applicable for this serving cell (servingCellId)
within the DCI payload.
positionInDCI-ForSUL
Starting position (in number of bit) of the ci-PayloadSize
bit CI value applicable for SUL of this serving cell
(servingCellId) within the DCI payload.
timeDurationForCI
Configures the duration of the reference time region in symbols
where a detected UL CI is applicable of this serving cell (servingCellId).
If the field is absent, i.e., the configured UL CI monitoring periodicity
indicated by monitoringSlotPeriodicityAndOffset for DCI format 2_4 is
larger than 1 slot or 1 slot with only one monitoring occasion, the
UE applies the value of the configured UL CI monitoring periodicity,
timeFrequencyRegion
Configures the reference time and frequency region where a detected
UL CI is applicable of this serving cell (servingCellId).
timeGranularityForCI
Configures the number of partitions within the time region of this
serving cell (servingCellId).
uplinkCancellationPriority
Configures uplink cancellation behaviour if both UL CI and intra-UE
priority indicator are configured for a given WTRU. If the field
is present, then UL CI is only applicable to the UL transmissions
indicated/configured as low priority level. If the field is absent,
UL CI is applicable to UL transmission irrespective of its priority level.

TABLE 3

| Conditional | |
|---|---|
| Presence | Explanation |
| SUL-Only | The field is optionally present, Need R, if |
| | supplementaryUplink is configured in |
| | ServingCellConfig. It is absent otherwise. |
| SymbolPeriodicity | This field is mandatory present if the configured |
| | UL CI monitoring periodicity indicated by |
| | monitoringSlotPeriodicityAndOffset for DCI |
| | format 2_4 is 1 slot with more than one |
| | monitoring occasion, otherwise absent. |

PUSCH aggregation is described herein. In NR, PUSCH time-domain resource allocation (TDRA) for data transmission is dynamicaly signaled in the DCI. This is useful as part of the slot available for uplink transmission may vary from slot to slot as a result of the use of dynamic TDD or the amount of resources used for uplink control signaling. Furthermore, the slot in which the transmission occurs also needs to be signaled as part of the time-domain allocation. Although downlink data are often transmitted in the same slot as the corresponding DCI assignment, this is frequently not the case for uplink transmissions.

DCI formats 0_0 and 0_1 may be used for dynamic PUSCH time-domain resource allocation. They carry an up to 4-bit “Time-domain resource allocation” field, which points to one of the rows of an up to 16-row look-up table where each row provides the following parameters: slots offset K2 used to indicate the offset to the slot for PUSCH transmission; SLIV (jointly coded Start and Length Indicator Values), used to derive values for the start symbol ‘S’ and the allocation length “L”; and “PUSCH mapping type” to be applied on the PUSCH transmission, Type A or Type B, which determines the first DM-RS symbol position.

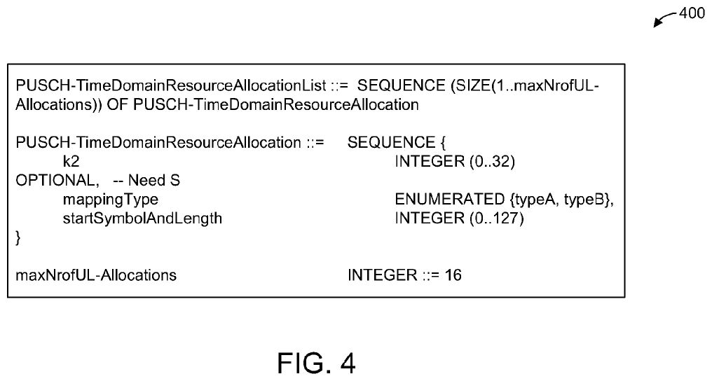

To this end, the RRC IE PUSCH-TimeDomainResourceAllocation is used to determine a time-domain offset between PDCCH and PUSCH. PUSCH-TimeDomainResourceAllocationList lists up to 16 PUSCH-TimeDomainResourceAllocations. The WTRU determines the bit width of the DCI field based on the number of entries in the PUSCH-TimeDomainResourceAllocationList. The DCI will indicate which of the configured time-domain allocations the WTRU must use for that UL grant. FIG. 4 400 shows an exemplary PUSCH-TimeDomainResourceAllocationList configuration.

In addition, configured grants can be used to facilitate uplink transmissions without a dynamic grant in order to reduce control signaling. Two types of configured grants are supported, differing in the ways they are activated: Configured grant type 1, where an uplink grant is provided by RRC, including activation of the grant; and Configured grant type 2, where the transmission periodicity is provided by RRC and L1/L2 signaling is used to activate the transmission.

Configured grant type 1 sets all the transmission parameters, including periodicity, time offset, and frequency resources as well as the modulation and coding scheme of possible uplink transmissions, using RRC signaling. Time-domain resource allocation for configured grant type 1 is carried out via RRC. PDCCH DCI 0_0 or 0_1 addressed to CS-RNTI (Configured Scheduling-RNTI) is used only for re-transmissions. Once the network configures time-domain resource using RRC, the only way to change the allocation is by sending RRC Reconfiguration message to the WTRU.

Configured grant type 2 is similar to downlink semi-persistent scheduling. That is, RRC signaling is used to configure the periodicity, while the transmission parameters are provided as part of the activation using PDCCH. Time-domain resource allocation in configured grant type 2 is done using PDCCH DCI 0_0 or 0_1 addressed to CS-RNTI (even for re-transmissions). Once configured and activated using DCI 0_0 or 0_1, the UE periodically uses same time-domain resources until the configured grant is de-activated.

Furthermore, NR supports slot aggregation for PUSCH transmissions, where the WTRU retransmits in consecutive slots (i.e., transmits the same TB over multiple consecutive slots) without waiting for feedback from the gNB. This is beneficial in cell edge scenarios in which re-transmissions are more probable. Slot aggregation is configured via RRC signaling using the following parameters:
pusch-AggregationFactor within PUSCH-Config IE is used for the case of dynamic scheduling. This field can take values of 2, 4 or 8 repetitions; pusch-AggregationFactor ENUMERATED {n2, n4, n8}
repK within ConfiguredGrantConfig IE is used for the case of configured grant. This field is mandatorily present and takes values of 1, 2, 4, and 8. Slot aggregation is activated when repK>1; repK ENUMERATED {n1, n2, n4, n8}

DCI format 0_2 allows enhanced flexibility in the field size, which can carry up to 6-bit “Time-domain resource allocation” corresponding to up to a 64-row look-up table in RRC. The “Time-domain resource allocation” field in the DCI format 0_2 is used as an index into an RRC configured table from which the time-domain allocation is obtained. Each row contains at least: A slot offset (K₂), that is, the slot relative to the one where DCI was received. In the uplink, the slot offsets from 0 to 7 can be used. The relatively large slot offset as compared to the downlink (0 to 3) is motivated by the need to schedule uplink transmission further into the future for coexistence with LTE TDD; The first OFDM symbol(S) in the slot where the data are transmitted; The duration of the transmission in number of OFDM symbols (L) in the slot.

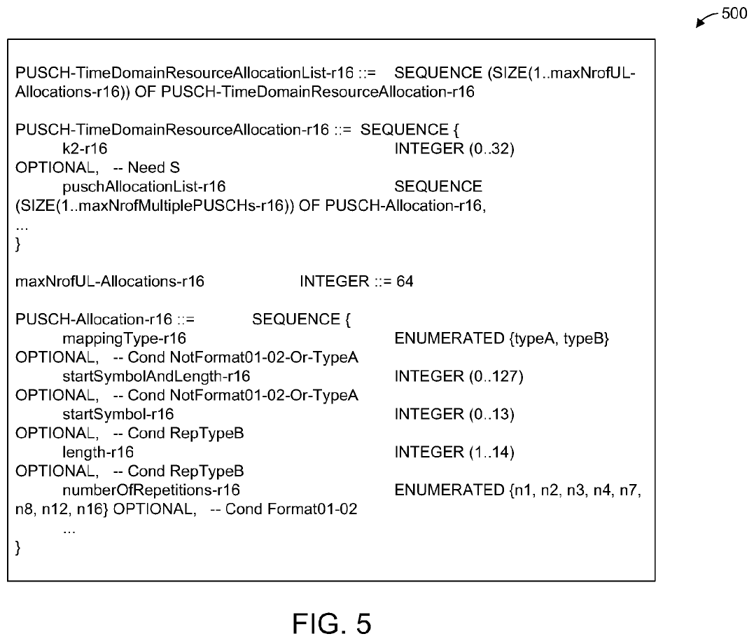

FIG. 5 500 shows an exemplary configuration for PUSCH-TimeDomainResourceAllocationList-16.

3GPP also defines default time-domain resource allocation tables that are used if no table is configured, as exemplified in Table 4. These default tables can be used until the necessary table configuration is provided. In many cases, the default table is sufficient, in which case there is no need to configure other values. Furthermore, additional columns can be configured in the table in R16. For example, to better support URLLC, the number of times a transmission should be repeated can be configured. Thus, it is possible to indicate slot aggregation (PUSCH repetition Type A) in a dynamic manner by properly configuring numberOfRepetitions-r16 in the time-domain resource allocation table. Table 4 shows Default PUSCH Time-Domain Resource Allocation for Normal CP.

TABLE 4

| | PUSCH | | | |
|---|---|---|---|---|
| Row index | mapping type | K₂ | S | L |
| 1 | Type A | j | 0 | 14 |
| 2 | Type A | j | 0 | 12 |
| 3 | Type A | j | 0 | 10 |
| 4 | Type B | j | 2 | 10 |
| 5 | Type B | j | 4 | 10 |
| 6 | Type B | j | 4 | 8 |
| 7 | Type B | j | 4 | 6 |
| 8 | Type A | j + 1 | 0 | 14 |
| 9 | Type A | j + 1 | 0 | 12 |
| 10 | Type A | j + 1 | 0 | 10 |
| 11 | Type A | j + 2 | 0 | 14 |
| 12 | Type A | j + 2 | 0 | 12 |
| 13 | Type A | j + 2 | 0 | 10 |
| 14 | Type B | j | 8 | 6 |
| 15 | Type A | j + 3 | 0 | 14 |
| 16 | Type A | j + 3 | 0 | 10 |

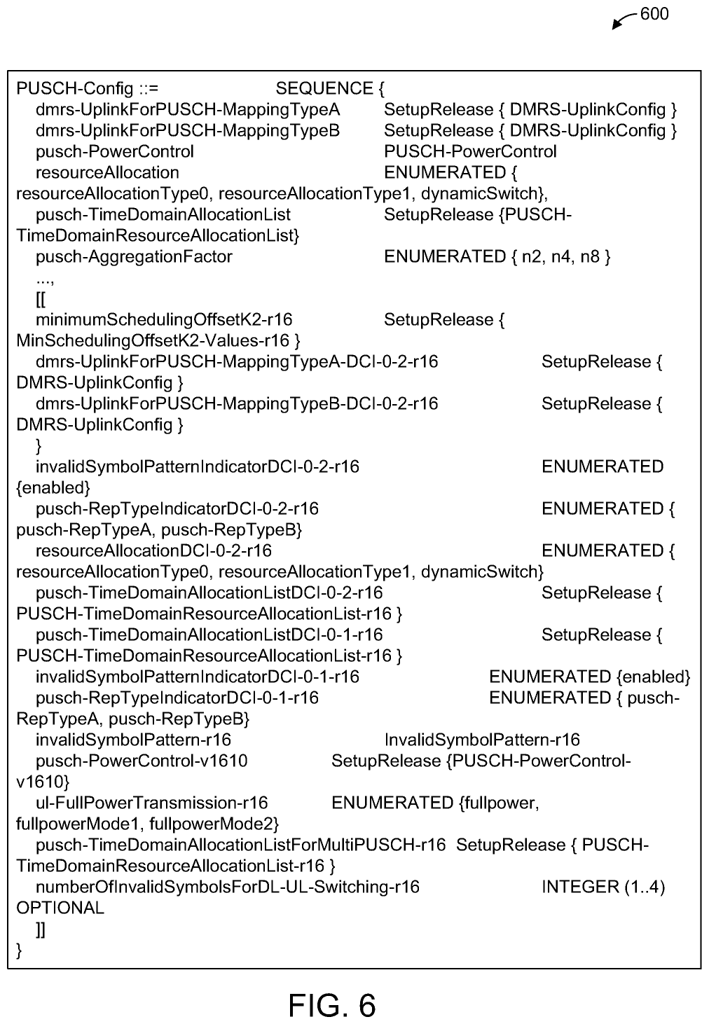

In addition, PUSCH repetition Type B may eliminate time gap among repetitions and because the repetitions are carried out in the consecutive sub-slots so one slot might contain more than one repetition of a transport block. For PUSCH scheduled by DCI format 0_1, if pusch-RepTypeIndicatorDCI-0-1-r16 is set to ‘pusch-RepTypeB’, the UE applies PUSCH repetition Type B procedure when determining the time-domain resource allocation. For PUSCH scheduled by DCI format 0_2, if pusch-Rep TypeIndicatorDCI-0-2-r16 is set to ‘pusch-RepTypeB’, the WTRU applies PUSCH repetition Type B procedure when determining the time-domain resource allocation. Otherwise, the WTRU applies PUSCH repetition Type A procedure when determining the time-domain resource allocation for PUSCH scheduled by PDCCH. FIG. 6 600 shows an exemplary PUSCH configuration.

For PUSCH repetition Type A, the starting symbol S relative to the start of the slot, and the number of consecutive symbols L counting from the symbol S allocated for the PUSCH are determined from the start and length indicator SLIV of the indexed row:

if (L − 1) ≤ 7 then
SLIV = 14 · (L − 1) + S
else
SLIV = 14 · (14 − L + 1) + (14 − 1 − S)

where 0<L≤14−S and

For PUSCH repetition Type B, the starting symbol S relative to the start of the slot, and the number of consecutive symbols L counting from the symbol S allocated for the PUSCH are provided by startSymbol and length of the indexed row of the resource allocation table, respectively.

For PUSCH repetition Type A, when transmitting PUSCH scheduled by DCI format 0_1 or 0_2 in PDCCH with CRC scrambled with C-RNTI, MCS-C-RNTI, or CS-RNTI with NDI=1, the number of repetitions K is determined as: if numberOfRepetitions is present in the resource allocation table, the number of repetitions K is equal to numberOfRepetitions; elseif the WTRU is configured with pusch-AggregationFactor, the number of repetitions K is equal to pusch-AggregationFactor, otherwise K=1.

For PUSCH transmissions with a Type 1 or Type 2 configured grant, the number of (nominal) repetitions K to be applied to the transmitted transport block is provided by the indexed row in the time-domain resource allocation table if numberOfRepetitions is present in the table; otherwise K is provided by the higher layer configured parameters repK.

For PUSCH repetition Type A, in case K>1, the same symbol allocation is applied across the K consecutive slots and the PUSCH is limited to a single transmission layer. The WTRU may repeat the TB (transport block) across the K consecutive slots applying the same symbol allocation in each slot. The redundancy version to be applied on the nth transmission occasion of the TB, where n=0, 1, . . . . K-1, is determined according to Table 5, below.

For PUSCH repetition Type B, after determining the invalid symbol(s) for PUSCH repetition type B transmission for each of the K nominal repetitions, the remaining symbols are considered as potentially valid symbols for PUSCH repetition Type B transmission. If the number of potentially valid symbols for PUSCH repetition type B transmission is greater than zero for a nominal repetition, the nominal repetition consists of one or more actual repetitions, where each actual repetition consists of a consecutive set of all potentially valid symbols that can be used for PUSCH repetition Type B transmission within a slot. An actual repetition with a single symbol is omitted except for the case of L=1. The WTRU may repeat the TB across actual repetitions. The redundancy version to be applied on the nth actual repetition (with the counting including the actual repetitions that are omitted) may be determined according to Table 5.

TABLE 5

| | rv_{id} to be applied to n^{th} | | | |
|---|---|---|---|---|
| | transmission occasion (repetition Type A) or | | | |
| rv_{id} indicated by | n^{th} actual repetition (repetition Type B) | | | |
| the DCI scheduling the | n mod | n mod | n mod | n mod |
| PUSCH | 4 = 0 | 4 = 1 | 4 = 2 | 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

PUSCH Power Boosting is described herein. For 5G uplink power control, a WTRU will first estimate the amount of power required to communicate with the gNB based on its own pathloss estimation (i.e., open loop power control). Subsequently, gNB will instruct the WTRU to increase or decrease the transmit power, typically to meet a pre-determined SINR target.

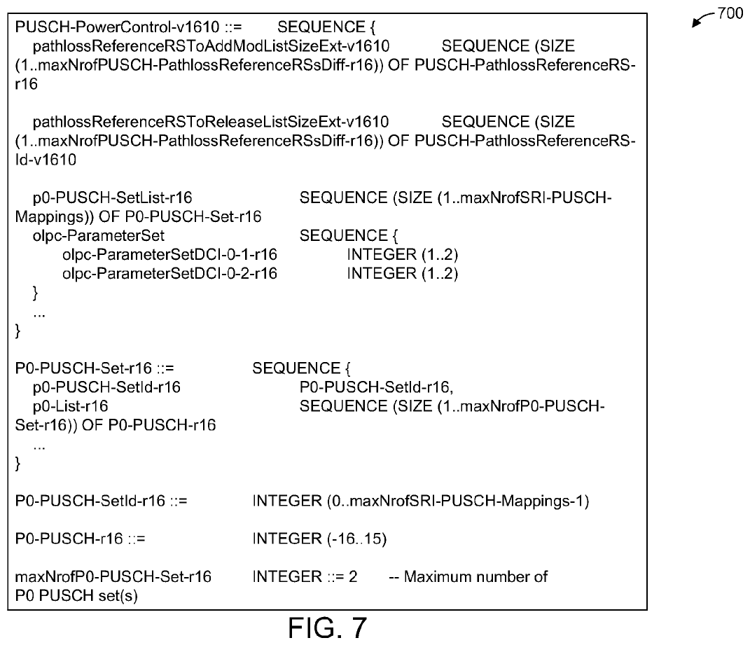

In embodiments, the WTRU may be configured with up to three values of the open-loop power control target received power parameter P0 for PUSCH. One of the P0 values corresponds to the normal transmission power, while the other (up to two) P0 values (p0-List-r16, shown in FIG. 7 700) are configured such that the transmission power is increased compared to the normal case. Which of the configured values to use is indicated in the scheduling via DCI Format 0_2 (power control parameter set). This way, the network can choose to dynamically boost the power of a high priority WTRU such that the interference from other WTRUs with overlapping time-frequency allocation is less of a problem and the high priority transmission is properly received.

Dynamic power boosting cannot be applied to the configured grants. It also assumes that the WTRU has available power to afford the boosting, something which may not be the case for the coverage limited scenarios where the WTRU has already reached its maximum power.

PUSCH MIMO is described herein: In NR, two different MIMO schemes are supported for PUSCH, codebook-based transmission and non-codebook-based transmission. The WTRU is configured with codebook-based transmission when the RRC parameter txConfig is set to “codebook”; the WTRU is configured with non-codebook-based transmission when the RRC parameter txConfig is set to “nonCodebook”. For both UL MIMO schemes, every UL channel transmission has the UL DM-RS precoded the same way as data. In the case of non-codebook-based UL MIMO, the manner in which the PUSCH precoded is not specified and the precoding itself is transparent to the gNB. In the case of codebook-based UL MIMO, the precoding follows the TPMI included in the UL grant; hence the precoding is non-transparent to the gNB.

In the UL, up to rank 4 spatial multiplexing is supported with CP-OFDM waveform. The MIMO layers are mapped to a single codeword, which means that the channel bits from a code block are distributed evenly across the layers. The modulation order and code rate are the same on all layers. The SNR on each layer can be different, but the single codeword arrangement ensures that the code blocks distributed across the layers will experience the same average SNR.

The basic principle of codebook-based PUSCH transmission is that the network decides on an uplink transmission rank, that is, the number of layers to be transmitted, and a corresponding precoder to use for the transmission. The network informs the WTRU about the selected transmission rank and precoder matrix as part of the uplink scheduling grant. At the WTRU side, the precoder matrix is then applied for the PUSCH transmission, mapping the indicated number of layers to the antenna ports.

To select a suitable rank and a corresponding precoder matrix, the network needs estimates of the channels between the WTRU antenna ports and the corresponding network receive antennas. To enable this, the WTRU configured for transmission for codebook based PUSCH would typically be configured for transmission of at least one multi-port SRS. Based on the measurements on the configured SRS, the network can sound the channel and determine a suitable rank and precoder matrix. Codebook-based precoding is typically used when uplink downlink reciprocity does not hold, that is, when uplink measurements are needed to determine a suitable uplink precoding.

In contrast to codebook-based precoding, non-codebook-based precoding is based on WTRU measurements and precoder indications to the network. Based on downlink measurements, e.g., measurements on a configured CSI-RS, the WTRU selects what it believes is a suitable uplink multi-layer precoder. Non-codebook-based precoding is thus based on the assumption of channel reciprocity, that is, the UE can acquire detailed knowledge of the uplink channel based on the downlink measurements.

In the case of non-codebook-based UL MIMO, WTRU autonomously decides the precoding to use for each SRS port/resource. The SRI in the PUSCH scheduling grant selects a subset of, or all of, these SRS resources for transmission of PUSCH and the WTRU then transmits one MIMO layer for each indicated SRS resource. The WTRU then transmits the PUSCH layer in the same way as it transmitted the indicated SRS resource in the most recent SRS resource transmission.

The following embodiments are described for ensuring robust and efficient PUSCH transmission and reception can occur when coexisting with RADARs: Cancelling resources scheduled for PUSCH transmission and reception to avoid time/frequency resources that will incur interference from RADARs. Dynamic triggering of PUSCH aggregation for UEs that will incur interference from RADARs. Power boosting of PUSCH transmissions for UEs that will incur interference from RADARs.

Cancelled Resources are described herein, including uplink pre-emption between WTRUs where the low priority transmission is cancelled. Scheduling a high priority uplink transmission on top of an already on-going low-priority transmission from another WTRU is possible. The cancellation indicator (CI) is a bitmap indicating a set of OFDM symbols and resource blocks upon which transmissions should be cancelled. Interpretation of the bitmap is configurable such that each bit represents one or more OFDM symbol in the time domain and a group of RBs within a bandwidth part. The cancellation indicator is transmitted using DCI format 2_4 scrambled with the CI-RNTI.

To coexist with a RADAR, a gNB may cancel time/frequency resources that will incur interference from the RADAR. The cancelled resources may correspond to contiguous or non-contiguous time/frequency resources. Upon the reception of cancellation indicator, WTRU my stop transmitting any PUSCH or SRS (but not PUCCH and RACH related UL transmissions) that (partially) overlaps with any of the cancelled resources (to be more specific, the WTRU stops the transmission starting from an indicated symbol and does not resume after that). The cancellation must come from a certain minimum time before the start of the PUSCH (or SRS) transmission to allow the UE to properly process and account for the cancellation indicator.

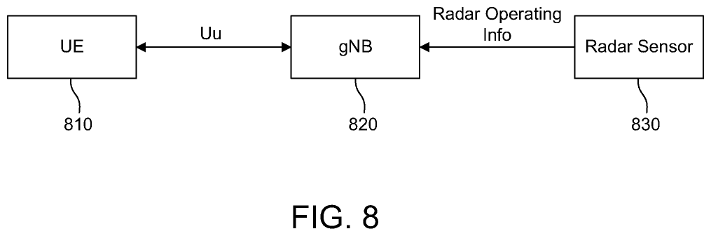

In embodiments, a gNB may use information characterizing the operation of RADAR to determine the cancelled resources. The gNB 820 may receive this information from an external entity 830 as shown in FIG. 8, which also shows a WTRU 810. Alternatively, the gNB may perform measurements to determine the information characterizing the operation of the RADAR. And in yet another alternative, measurements performed by the gNB may be used in combination with information provided by an external entity to characterize the operation of the RADAR.

Silencing periods may be used to allow RADAR measurements to be performed by an external entity and/or the gNB. In one example, the silencing periods may be implemented by the gNB as scheduling gaps; i.e., the gNB will not schedule UL/DL transmissions during the period(s) when the measurements are being performed.

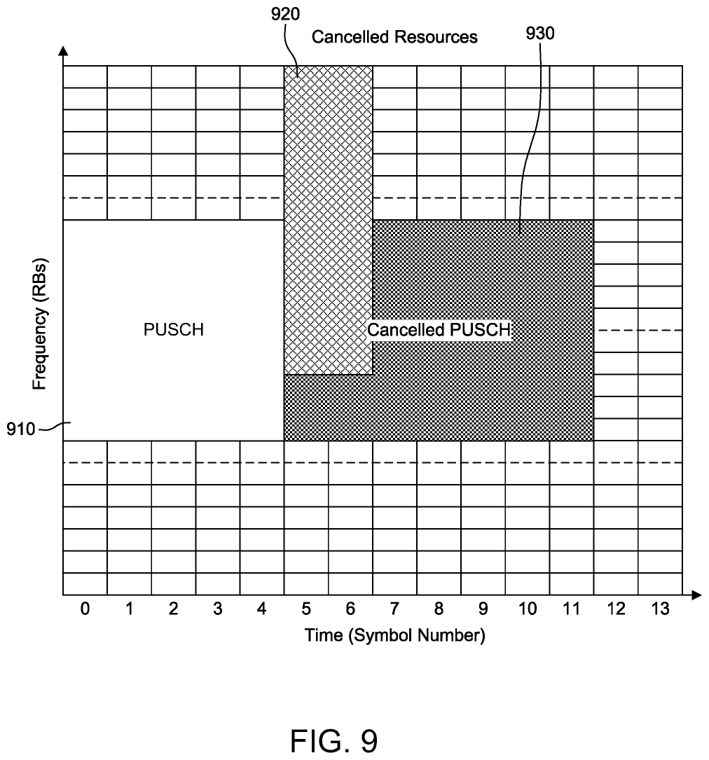

The determination of the cancelled resources may be based on time/frequency information characterizing the operation of the RADAR; e.g., frequency, bandwidth, and period. For example, the frequency and bandwidth of the RADAR burst may be used to determine the frequency resources allocated as cancelled resources; and the start time and duration of a RADAR burst may be used to determine the symbols allocated as cancelled resources on top of already scheduled PUSCH resources. FIG. 9 shows the cancelled resources for the scenario where the RADAR is operating such that the PUSCH transmission 910 would incur interference during symbols 5 and 6, 920 and partially overlapped with the allocated PUSCH bandwidth.

The gNB may consider the direction of the PUSCH transmission when determining whether or not cancelled resources are needed to coexist with the RADAR. For example, resources may only be cancelled for PUSCH transmissions in directions that would incur RADAR interference.

In one example, RADAR AOA information is used by the gNB to determine the spatial direction of the RADAR interference in the cell. The gNB would then use cancelled resources 930 to stop PUSCH transmissions from UEs located in areas of the cell that would incur RADAR interference.

The gNB may determine a WTRU's effective “communication” direction based on the spatial direction of an SSB or CSI-RS that is used for reception of the PUSCH. Alternatively, the UE's location may be determined by the gNB using positioning algorithms, may be (pre) configured in the gNB via an Operations, Administration and Maintenance (OAM) interface, or may be reported to the gNB by the WTRU.

The gNB may also consider the interference level when determining whether or not cancelled resources are needed to coexist with the RADAR. For example, resources may only be cancelled when the interference from the RADAR is above a threshold. The threshold may be preconfigured, determined dynamically or provided by an external entity.

Different thresholds may be defined and selected by the gNB. For example, a set of thresholds may be defined based on the MCS or modulation order. The gNB may then select the appropriate threshold based on the MCS or modulation order used for the PUSCH. In further embodiments, the threshold may be selected based on characteristics of the data, characteristics of the service and/or characteristics of the device; e.g., the QoS of the data being transmitted on the PUSCH, the service being provided to the device, the device type.

The (re-)configuration of the cancelled resources bitmap definition may be done using broadcast or dedicated higher layer signaling. For scenarios where broadcast signaling is used, a UE could be made aware of the change to the cancelled resources configuration by setting the systemInfoModification bit of the short message. The WTRU may then acquire the new cancelled resources bitmap configuration using the SI acquisition procedure at the start of the next modification period. A bitmap in the DCI format_2_4 can be used to enable or disable the cancelled resources depending on whether or not the WTRU will incur interference from the RADAR and whether or not there is scheduled PUSCH transmission for the WTRU.

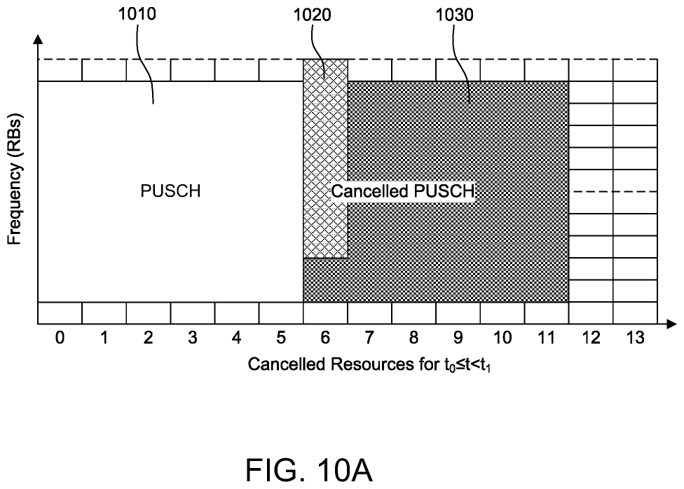

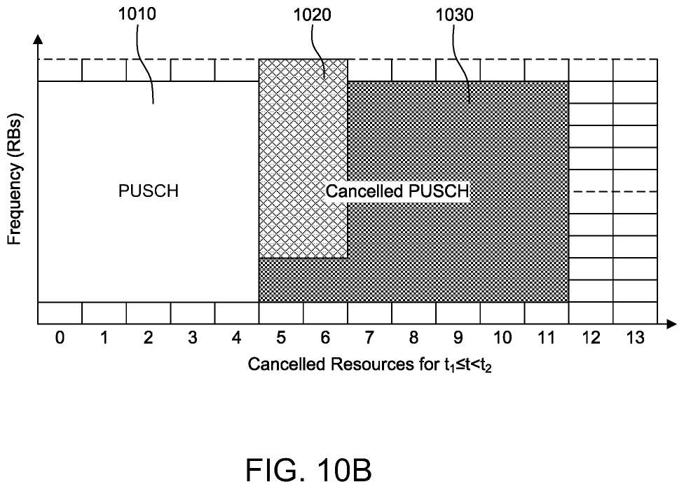

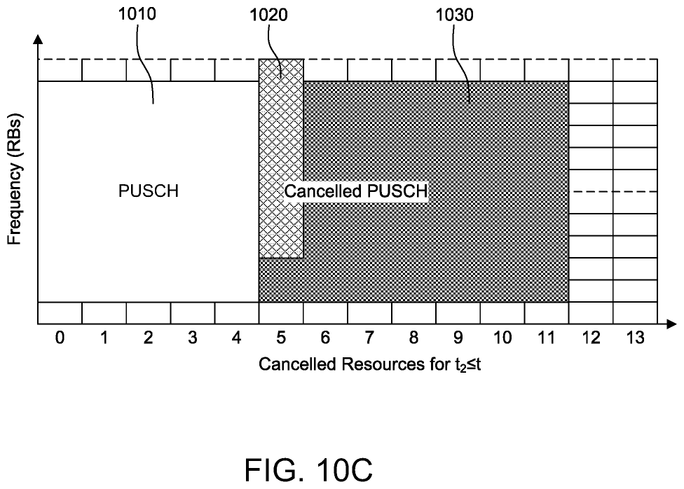

Adaption of cancelled resources for timing drift is described herein. Time synchronization cannot be assumed between the gNB and RADAR, therefore, the pattern of symbols that incur RADAR interference may drift over time. In embodiments, the gNB may reset the bitmap of the cancelled resources as the symbols that incur RADAR interference drift over time. FIG. 10A is an illustration of an example where symbol 6 of cancelled PUSCH resources 1030 incurs RADAR interference 1020 for t₀≤t<t₁. PUSCH resources 1010 for symbols 0-5 are unaffected at this time frame. FIG. 10B is an example where symbols 5 and 6 incur interference 1020 for t₁≤t<t₂. FIG. 10C is an example where and symbol 5 incurs interference 1020 for t₂≤t. In these examples, the time duration of the RADAR interference is assumed to be less than or equal to the time duration of a symbol. However, the same concept may also be applied for scenarios where the time duration of the RADAR interference is greater than the time duration of a symbol.

The reset of the cancelled resources may be done using the bitmap in the scheduling DCI format_2_4 to enable or disable the cancelled resources depending on whether or not the WTRU will incur interference from the RADAR and whether or not there is scheduled PUSCH transmission for the WTRU.

PUSCH aggregation is described herein. To coexist with a RADAR, a gNB may configure PUSCH aggregation for WTRUs that will incur interference from the RADAR. The configuration of PUSCH aggregation may be triggered for a WTRU when the RADAR interference exceeds a threshold. The threshold may be preconfigured, determined dynamically or provided by an external entity. Different thresholds may be defined and selected by the gNB. For example, a set of thresholds may be defined based on the MCS or modulation order. The gNB would then select the appropriate threshold based on the MCS or modulation order used for the PUSCH. In other embodiments, the threshold may be selected based on characteristics of the data, characteristics of the service and/or characteristics of the device; e.g., the QoS of the data being transmitted on the PUSCH, the service being provided to the device, the device type.

The gNB may use information characterizing the operation of the RADAR to determine the interference level. In one example, RADAR AOA information is used by the gNB to determine the spatial direction of the RADAR interference in the cell. The gNB may then configure PUSCH aggregation for WTRUs located in areas of the cell that would incur RADAR interference exceeding a threshold. The gNB may determine a WTRU's effective “communication” direction based on the spatial direction of an SSB or CSI-RS that is used for reception of the PUSCH. Alternatively, the WTRU's location may be determined by the gNB using positioning algorithms, may be (pre) configured in the gNB via an OAM interface, or may be reported to the gNB by the WTRU.

In embodiments, the gNB may consider the interference level when determining the numberOfRepetitions/pusch-AggregationFactor/repK for PUSCH aggregation. For example, thresholds may be used to define the numberOfRepetitions over a range of interference levels as shown in Table 6.

TABLE 6

| Interference Level | numberOfRepetitions |
|---|---|
| Interference Level < threshold₁ | 1 |
| threshold₁ ≤ Interference Level < Threshold₂ | 2 |
| threshold₂ ≤ Interference Level < Threshold₃ | 4 |
| threshold₃ ≤ Interference Level < Threshold₄ | 8 |
| threshold₄ ≤ Interference Level | 16 |

Broadcast or dedicated higher layer signaling may be used for (re-)configuration of PUSCH aggregation. Alternatively, DCI may be used to dynamically configure PUSCH aggregation. For example, DCI format 0_2 may be used to dynamically configure the index that points to a specific numberOfRepetitions value in the RRC configured time-domain resource allocation table to be used for a given PUSCH transmission.

PUSCH aggregation discussed so far is applied in the time domain with single layer transmission. In a rich scattering environment (and/or dual polarization) with rank >1, multi-layer MIMO transmissions (either codebook-based or non-codebook-based) are possible. In this scenario, multiple redundancy versions can be transmitted simultaneously over multiple layers (termed PUSCH layer aggregation), while using the same HARQ process, to improve HARQ efficiency rather than system capacity. For non-codebook-based UL MIMO, the network may exclude SRI(s) that are most significantly impacted by the RADAR.

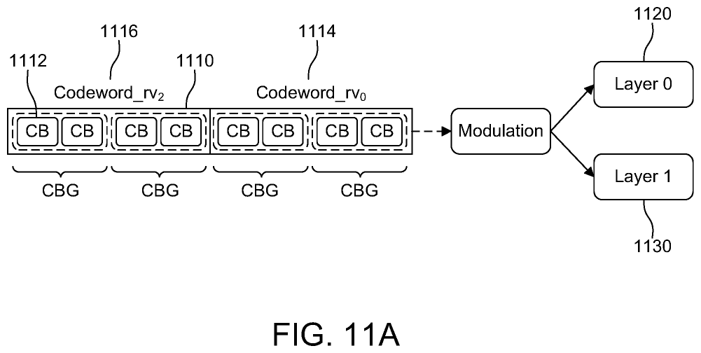

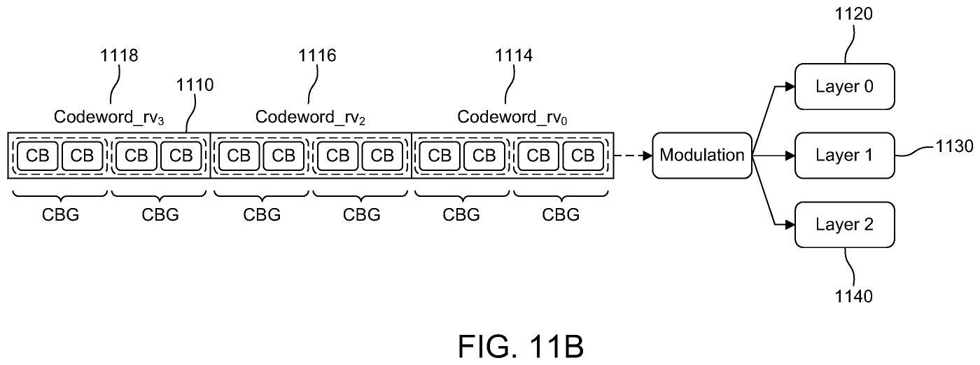

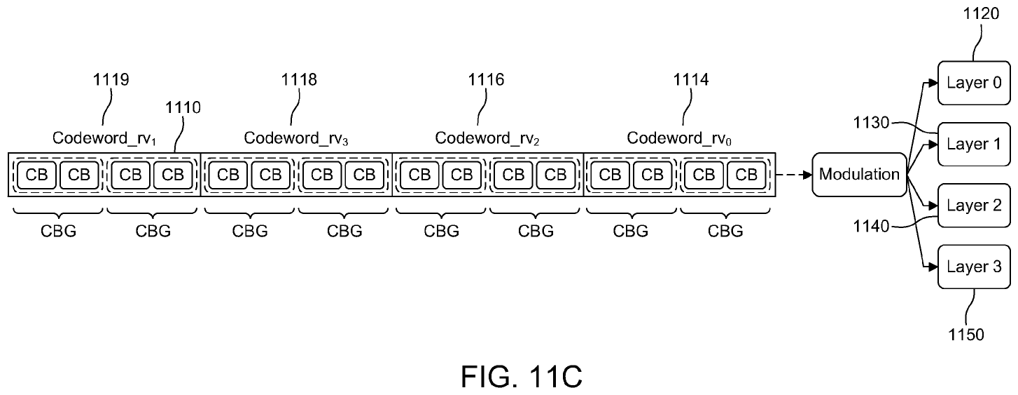

In one embodiment, the channel bits from each code block (CB) 1110 of the multiple redundancy versions are distributed evenly across MIMO layers, as illustrated in FIGS. 11A (rank=2), 11B (rank 3) and 11C (rank=4). CBG indicates code block group.

FIG. 11A shows codewords rv₀ 1114 and rv₂ 1116 both mapped serially 1110 to Layer 0 1120 and Layer 1 1130.

FIG. 11B shows codewords rv₀ 1114, rv₂ 1116 and rv₃ 1118 all mapped serially 1110 to Layer 0 1120, Layer 1 1130 and Layer 2 1140.

FIG. 11C shows codewords rv₀ 1114, rv₂ 1116 and rv₃ 1118 and rv₁ all mapped serially 1110 to Layer 0 1120, Layer 1 1130, Layer 2 1140 and Layer 3 1150.

The SNR on each layer can be different, but the code blocks distributed across the layers will experience the same average SNR.

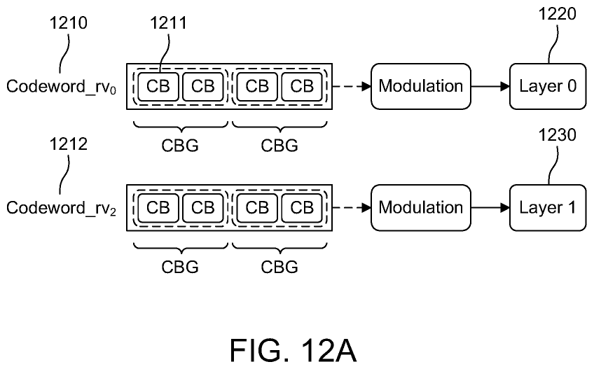

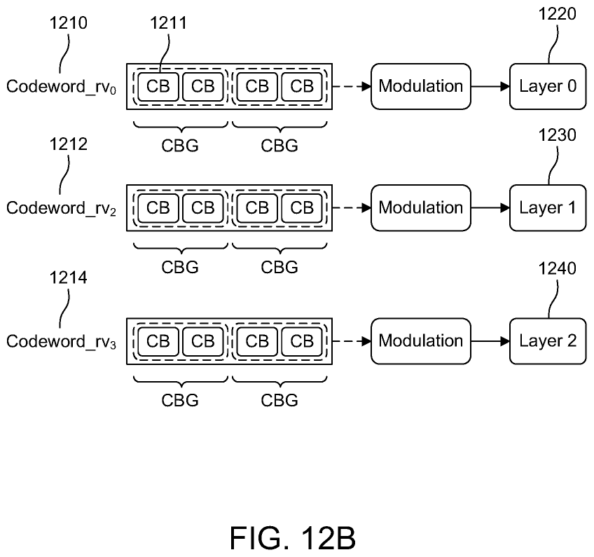

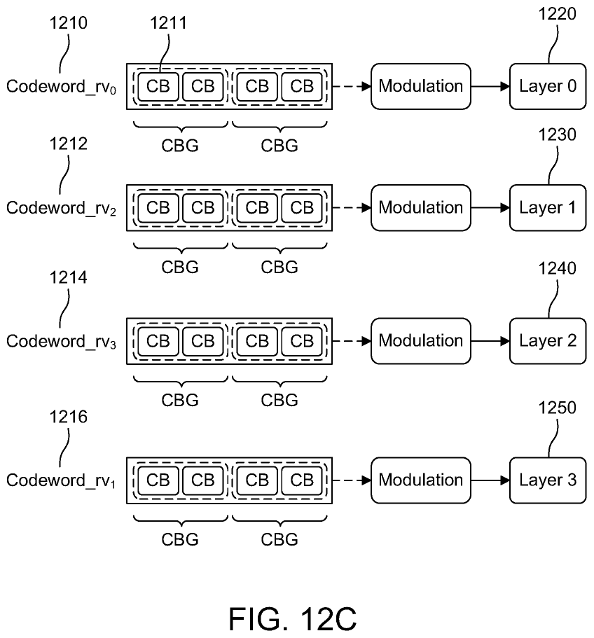

In a further embodiment, the codewords associated with different redundancy versions are mapped in a parallel manner to different MIMO layers, as illustrated in FIGS. 12A (rank=2), 12B (rank=3) and 12C (rank=4). In this embodiment, the codewords associated with different redundancy versions may experience different SNRs.

FIG. 12A shows codeword rv₀ 1210 mapped to Layer 0 1220 and codeword rv₂ mapped to Layer 1 1230. Individual code blocks are marked 1211.

FIG. 12B shows codeword rv₀ 1210 mapped to Layer 0 1220, codeword rv₂ mapped to Layer 1 1230 and codeword rv₃ 1214 mapped to Layer 2 1240.

FIG. 12C shows codeword rv₀ 1210 mapped to Layer 0 1220, codeword rv₂ mapped to Layer 1 1230, codeword rv₃ 1214 mapped to Layer 2 1240 and codeword rv₁ 1216 mapped to Layer 3 1250.

In embodiments, the network may trigger PUSCH layer aggregation via the scheduling grant. For example, a “layer aggregation” bit may be defined in DCI format 0_1 and format 0_2. When the layer aggregation bit is set to 0, redundancy versions are determined by Table 5 (shown above). On the other hand, when the layer aggregation bit is set to 1, redundancy versions will be determined by Table 7, Table 8 or Table 9 if the uplink MIMO rank is equal to 2, 3, or 4, respectively. Note that in the case when time domain repetition is not applied, redundancy versions for layer aggregation will be determined in the redundancy versions tables with n=0.

TABLE 7

| | rv_{id} to be applied to n^{th} | | | |
|---|---|---|---|---|
| rv_{id} indicated by | transmission occasion (repetition Type A) or | | | |
| the DCI scheduling | n^{th} actual repetition (repetition Type B) | | | |
| the PUSCH layer | n mod | n mod | n mod | n mod |
| [0, 1] | 4 = 0 | 4 = 1 | 4 = 2 | 4 = 3 |
| 0 | [0, 2] | [3, 1] | [2, 3] | [1, 0] |
| 2 | [2, 3] | [1, 0] | [3, 1] | [0, 2] |
| 3 | [3, 1] | [0, 2] | [1, 0] | [2, 3] |
| 1 | [1, 0] | [2, 3] | [0, 2] | [3, 1] |

TABLE 8

| | rv_{id} to be applied to n^{th} | | | |
|---|---|---|---|---|
| rv_{id} indicated by | transmission occasion (repetition Type A) or | | | |
| the DCI scheduling | n^{th} actual repetition (repetition Type B) | | | |
| the PUSCH layer | n mod | n mod | n mod | n mod |
| [0, 1, 2] | 4 = 0 | 4 = 1 | 4 = 2 | 4 = 3 |
| 0 | [0, 2, 3] | [3, 1, 0] | [2, 3, 1] | [1, 0, 2] |
| 2 | [2, 3, 1] | [1, 0, 2] | [3, 1, 0] | [0, 2, 3] |
| 3 | [3, 1, 0] | [0, 2, 3] | [1, 0, 2] | [2, 3, 1] |
| 1 | [1, 0, 2] | [2, 3, 1] | [0, 2, 3] | [3, 1, 0] |

TABLE 9

| | rv_{id} to be applied to n^{th} | | | |
|---|---|---|---|---|
| rv_{id} indicated by | transmission occasion (repetition Type A) or | | | |
| the DCI scheduling | n^{th} actual repetition (repetition Type B) | | | |
| the PUSCH layer | n mod | n mod | n mod | n mod |
| [0, 1, 2] | 4 = 0 | 4 = 1 | 4 = 2 | 4 = 3 |
| 0 | [0, 2, 3, 1] | [3, 1, 0, 2] | [2, 3, 1, 0] | [1, 0, 2, 3] |
| 2 | [2, 3, 1, 0] | [1, 0, 2, 3] | [3, 1, 0, 2] | [0, 2, 3, 1] |
| 3 | [3, 1, 0, 2] | [0, 2, 3, 1] | [1, 0, 2, 3] | [2, 3, 1, 0] |
| 1 | [1, 0, 2, 3] | [2, 3, 1, 0] | [0, 2, 3, 1] | [3, 1, 0, 2] |

In embodiments, a “layer sub-aggregation bit” may be further defined for rank>2 to subdivide the number of layers to be aggregated and facilitate tradeoff between reliability and capacity. For example, if the layer sub-aggregation bit is set to 1, redundancy versions can be determined by Table 10 or Table 11, if the downlink MIMO rank is equal to 3 or 4, respectively. Note that the ‘layer sub-aggregation bit’ is sent only when rank>2 and ‘layer aggregation bit’ is set to 1.

TABLE 10

| | rv_{id} to be applied to n^{th} | | | |
|---|---|---|---|---|
| rv_{id} indicated by | transmission occasion (repetition Type A) or n^{th} | | | |
| the DCI scheduling | actual repetition (repetition Type B) | | | |
| the PUSCH layer | n mod | n mod | n mod | n mod |
| [0, 1, 2] | 4 = 0 | 4 = 1 | 4 = 2 | 4 = 3 |
| 0 | [0, 2, 0] | [3, 1, 3] | [2, 3, 2] | [1, 0, 1] |
| 2 | [2, 3, 2] | [1, 0, 1] | [3, 1, 3] | [0, 2, 0] |
| 3 | [3, 1, 3] | [0, 2, 0] | [1, 0, 1] | [2, 3, 2] |
| 1 | [1, 0, 1] | [2, 3, 2] | [0, 2, 0] | [3, 1, 3] |

TABLE 11

| | rv_{id} to be applied to n^{th} | | | |
|---|---|---|---|---|
| rv_{id} indicated by | transmission occasion (repetition Type A) or | | | |
| the DCI scheduling | n^{th} actual repetition (repetition Type B) | | | |
| the PUSCH layer | n mod | n mod | n mod | n mod |
| [0, 1, 2, 3] | 4 = 0 | 4 = 1 | 4 = 2 | 4 = 3 |
| 0 | [0, 2, 0, 2] | [3, 1, 3, 1] | [2, 3, 2, 3] | [1, 0, 1, 0] |
| 2 | [2, 3, 2, 3] | [1, 0, 1, 0] | [3, 1, 3, 1] | [0, 2, 0, 2] |
| 3 | [3, 1, 3, 1] | [0, 2, 0, 2] | [1, 0, 1, 0] | [2, 3, 2, 3] |
| 1 | [1, 0, 1, 0] | [2, 3, 2, 3] | [0, 2, 0, 2] | [3, 1, 3, 1] |

In addition to the bundled transmission described above, layer aggregation may also be applied in the regular HARQ process. For example, the network sends redundancy version 0 during initial transmission and retransmitted multiple redundancy versions of the erroneous CBGs using layer aggregation (assuming rank>1 is available during retransmission) to enhance reliability and reduce latency. In principle, the network can also send multiple redundancy versions of the erroneous CBGs using both layer aggregation and repetition, if deemed beneficial. A WTRU should inform the network of its capability to support PUSCH layer aggregation, as exemplified by the following information message in Table 12.

TABLE 12

| | | | FDD − TDD | FR1 − FR2 |
|---|---|---|---|---|
| Definition of parameter | Per | M | DIFF | DIFF |
| pusch LayerAggregation | WTRU | No | No | No |
| Indicates whether the WTRU | | | | |
| supports PUSCH layer | | | | |
| aggregation | | | | |

PUSCH Power Boosting is described herein. One way to reduce interference to the RADAR is for gNB to avoid using the time-frequency resources when the RADAR is actively transmitting or listening for the return pulses. This is known as PRB blanking. Based on the estimates of RADAR rotation timing estimates and the power spectral density (PSD), the time-frequency interference region is evaluated and the gNB scheduler avoids allocating the corresponding PRBs for uplink or downlink traffic.

On the other hand, PRB blanking can lead to uplink cell throughput degradation due to the reduced radio resources. To this end, it is possible to boost the PUSCH transmission power to mitigate the uplink cell throughput impact after PRB blanking is triggered, without the risk of harming the RADAR (since the power boosting is performed outside the RADAR bandwidth). In embodiments, PUSCH power boosting can also be triggered without PRB blanking, as long as the interference from the 5G WTRUs to RADAR is not at risk (while the interference from RADAR to 5G is still significant), e.g., when the RADAR is sufficiently far away, or when the main beam of RADAR is not pointing toward the 5G system.

In embodiments, power boosting may be triggered for a WTRU when RADAR interference exceeds a threshold. The threshold may be preconfigured, determined dynamically or provided by an external entity. Different thresholds may be defined and selected by the gNB. For example, a set of thresholds may be defined based on the MCS or modulation order. The gNB would then select the appropriate threshold based on the MCS or modulation order used for the PUSCH. In further embodiments, the threshold may be selected based on characteristics of the data, characteristics of the service and/or characteristics of the device; e.g., the QoS of the data being transmitted on the PUSCH, the service being provided to the device, and the device type. The gNB may use information characterizing the operation of the RADAR to determine the interference level. In one example, RADAR AOA information is used by the gNB to determine the spatial direction of the RADAR interference in the cell. The gNB would then use power boosting for WTRUs located in areas of the cell that would incur RADAR interference exceeding a threshold.

The gNB may determine a WTRU's effective “communication” direction based on the spatial direction of an SSB or CSI-RS that is used for reception of the PUSCH. Alternatively, the WTRU's location may be determined by the gNB using positioning algorithms, may be (pre) configured in the gNB via an OAM interface, or may be reported to the gNB by the WTRU.

For WTRUs supporting power boosting, power boosting can be explicitly performed by employing a target received power P0 higher than the nominal P0 value for outer loop power control via dynamic scheduling. In this regard, the SINR target in the gNB for the inner loop power control also needs to be increased correspondingly. For WTRUs that do not support power boosting capability, the P0 values may be updated via RRC signaling, along with the SINR target increase. Note that since R16 only supports the configuration of two additional P0 values, more than two can be considered to provide further flexibility.

In an embodiment of the disclosures herein, a gNB may be configured to execute the instructions of: receiving information characterizing the operation of a RADAR; based on the received information, determining the time/frequency resources that may incur interference from the RADAR; based on the determined time/frequency resources, configuring WTRUs with the definition of the bitmap of cancelled time/frequency resources that should not be used for PUSCH transmission; identify WTRUs that need to apply cancelled resources and scheduling cancelled resources to prohibit the identified WTRUs from utilizing the cancelled resources for PUSCH transmission, despite any previous scheduling grants. In further aspects of this embodiment: the information characterizing the operation of a RADAR may include: Angle of Arrival (AOA), frequency, Bandwidth (BW), etc. Wherein the configuring a WTRU with a set of cancelled time/frequency resources further comprises: determining the WTRU will incur interference from the RADAR based on the WTRU's location in the cell. In further aspects of this embodiment determining the WTRU's communication direction may be based on the spatial direction of an SS/PBCH block (SSB) or Channel State Information Reference Signal (CSI-RS) that is used for reception of the PUSCH. In further aspects of this embodiment the determining the time/frequency resources that may incur interference from the RADAR may further comprise determining the interference from the RADAR is above a threshold, in addition, the Modulation and Coding Scheme (MCS) of the PUSCH may be used to select the threshold from a set of thresholds based on the MCS. In further aspects of this embodiment, the set of cancelled time/frequency resources corresponds to RBs in one or more of the symbols allocated for the PUSCH transmission. In further aspects of this embodiment, the definition of the bitmap of cancelled time/frequency resources are configured via broadcast or dedicated higher layer signaling, and dynamically enabled/disabled via a bitmap in the Downlink Control Information (DCI). In further aspects of this embodiment, reconfiguration of the cancelled time/frequency resources is triggered in response to timing drift between the gNB and RADAR.

In an embodiment of the disclosures herein, a gNB may be configured to execute the instructions of: configuring a time-domain resource allocation table to include one or more repetition options for PUSCH aggregation; receiving information characterizing the operation of a RADAR; based on the received information, determining the time/frequency resources that may incur interference from the RADAR; determining the rank of the PUSCH transmission; if rank>1, determining whether to include layer aggregation to combat RADAR interference; determining the modulation order and coding rate of the PUSCH transmission; determining a set of RBs to be allocated to a WTRU for PUSCH transmission; determining the PUSCH aggregation (repetition) factor to be used to overcome interference from the RADAR; and scheduling the WTRU to transmit the PUSCH using PUSCH time domain repetition and/or layer aggregation. In further aspects of this embodiment, the information characterizing the operation of a RADAR may include: AOA, frequency, BW, etc. In further aspects of this embodiment determining the set of RBs comprising time/frequency resources that may incur interference from the RADAR further comprises determining the WTRU will incur interference from the RADAR based on the WTRU's location in the cell. In further aspects of this embodiment, the WTRU's effective communication direction is determined based on the spatial direction of an SSB or CSI-RS that is used for reception of the PUSCH. In further aspects of this embodiment, determining the time/frequency resources that may incur interference from the RADAR further comprises determining whether the interference from the RADAR exceeds a threshold. In further aspects of this embodiment, the MCS of the PUSCH may be used to select the threshold from a set of thresholds based on the MCS. In further aspects of this embodiment, the extent of PUSCH aggregation (including time-domain repetition and/or layer aggregation) is determined based on one or more of the following: the MCS of the PUSCH; and/or the interference from the RADAR exceeding a threshold; and/or the Quality-of-Service (QoS) of the data being transmitted on the PUSCH. In further aspects of this embodiment, the PUSCH aggregation/repetition factor may be configured via broadcast or dedicated higher layer signaling, while time-domain repetition and/or layer aggregation of PUSCH may be dynamically enabled/disabled via DCI.

In an embodiment of the disclosures herein, a gNB may be configured to execute the instructions of: receiving information characterizing the operation of a RADAR; based on the received information, determining the time/frequency resources that may incur interference from the RADAR; determining a set of RBs to be allocated to a WTRU for PUSCH transmission; determining whether a WTRU will require power boosting for PUSCH transmission to overcome interference from the RADAR and/or to mitigate the cell capacity reduction due to PRB blanking; and informing WTRU to perform PUSCH transmission using power boosting, as identified. In further aspects of this embodiment, the information characterizing the operation of a RADAR may include: AOA, frequency, BW, etc. In further aspects of this embodiment, determining whether the resources allocated to a WTRU for PUSCH transmission will require power boosting to overcome interference from the RADAR and/or to mitigate the cell capacity reduction due to PRB blanking further comprises determining the WTRU will incur interference from the RADAR based on the WTRU's location in the cell. In further aspects of this embodiment, the WTRU's effective communication direction is determined based on the spatial direction of an SSB or CSI-RS that is used for reception of the PUSCH. In further aspects of this embodiment, determining the time/frequency resources that may incur interference from the RADAR further comprises: determining the interference from the RADAR exceeds a threshold. In further aspects of this embodiment, the MCS of the PUSCH may be used to select the threshold from a set of thresholds based on the MCS. In further aspects of this embodiment, a set of PUSCH target received power P0 can be configured via broadcast or dedicated higher layer signaling, and dynamically selected via dedicated DCI signaling. In further aspects of this embodiment, WTRU-group common signaling may be used to select the target received power p0 for PUSCH for a group of WTRUs. In further aspects of this embodiment, a MAC-CE may be used to select the target received power p0 for PUSCH.

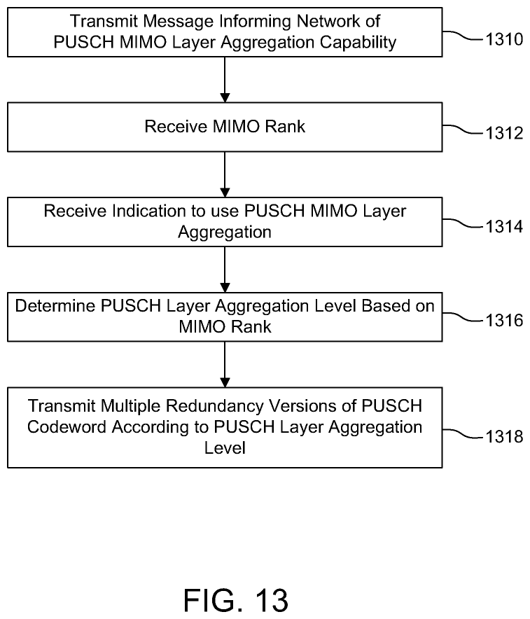

FIG. 13 is a flow diagram showing an exemplary process implemented by a wireless transmit/receive unit (WTRU) according to embodiments disclosed herein. At 1310 the WTRU transmits a message informing a network of PUSCH MIMO layer aggregation capability. At 1312, the WTRU receives a MIMO rank. At 1314 the WTRU receives an indication to use PUSCH MIMO layer aggregation (with or without sub-aggregation). At 1316 the WTRU determines a PUSCH layer aggregation level based on the MIMO rank along with possible sub-aggregation indication. At 1318, the WTRU transmits multiple redundancy versions of a PUSCH codeword comprising one or more code blocks based on the PUSCH layer aggregation level. The method of claim 1, wherein for each redundancy version, every code block of the PUSCH codeword is distributed evenly across multiple MIMO layers. In further embodiments, the code blocks for different redundancy versions of the codeword are mapped to different MIMO layers. In further embodiments, the indication to use PUSCH MIMO layer aggregation is made by a DCI signaling bit. In further embodiments, the PUSCH MIMO layer aggregation is made in a HARQ process. In further embodiments the indication to use PUSCH MIMO layer aggregation includes an indication to use sub-aggregation. In further embodiments, the PUSCH layer aggregation level is determined based on the MIMO rank and the sub-aggregation indication. In further embodiments, the PUSCH layer aggregation level is further based on an interference level. In further embodiments, the interference level is related to a RADAR signal.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a wireless transmit/receive unit (WTRU) comprising:
transmitting a message informing a network of physical uplink shared channel (PUSCH) multiple input multiple output (MIMO) layer aggregation capability;
receiving a MIMO rank;
receiving an indication to use PUSCH MIMO layer aggregation;
determining a PUSCH layer aggregation level based on the MIMO rank; and
transmitting multiple redundancy versions of a PUSCH codeword comprising one or more code blocks based on the PUSCH layer aggregation level, wherein the indication to use PUSCH MIMO layer aggregation includes an indication to use sub-aggregation, which indicates that the number of aggregated MIMO layers is less than the MIMO rank.

2. The method of claim 1, wherein for each of the multiple redundancy versions, every code block of the PUSCH codeword is distributed evenly across multiple MIMO layers.

3. The method of claim 1, wherein the code blocks for different redundancy versions of the codeword are mapped to different MIMO layers.

4. The method of claim 1, wherein the indication to use PUSCH MIMO layer aggregation is made by a downlink control information (DCI) signaling bit.

5. The method of claim 1, wherein PUSCH MIMO layer aggregation is made in a hybrid automatic repeat request (HARQ) process.

6. The method of claim 1 wherein the indication to use PUSCH MIMO layer aggregation includes an indication to use sub-aggregation.

7. The method of claim 6, wherein the PUSCH layer aggregation level is determined based on the MIMO rank and the sub-aggregation indication.

8. The method of claim 1, wherein the PUSCH layer aggregation level is further based on an interference level.

9. The method of claim 8, wherein the interference level is related to a RADAR signal.

10. A wireless transmit/receive unit (WTRU) comprising:
a transmitter;
a receiver; and
a processor in communication with the transmitter and receiver, the processor and transmitter or receiver configured to:
transmit a message informing a network of physical uplink shared channel (PUSCH) multiple input multiple output (MIMO) layer aggregation capability;
receive a MIMO rank;
receive an indication to use PUSCH MIMO layer aggregation;
determine a PUSCH layer aggregation level based on the MIMO rank; and
transmit multiple redundancy versions of a PUSCH codeword comprising one or more code blocks based on the PUSCH layer aggregation level, wherein the indication to use PUSCH MIMO layer aggregation includes an indication to use sub-aggregation, which indicates that the number of aggregated MIMO layers is less than the MIMO rank.

11. The WTRU of claim 10, wherein for each of the multiple redundancy versions, every code block of the PUSCH codeword is distributed evenly across multiple MIMO layers.

12. The WTRU of claim 10, wherein the code blocks for different redundancy versions of the codeword are mapped to different MIMO layers.

13. The WTRU of claim 10, wherein the indication to use PUSCH MIMO layer aggregation is made by a downlink control information (DCI) signaling bit.

14. The WTRU of claim 10, wherein PUSCH MIMO layer aggregation is made in a hybrid automatic repeat request (HARQ) process.

15. The WTRU of claim 10, wherein the indication to use PUSCH MIMO layer aggregation includes an indication to use sub-aggregation.

16. The WTRU of claim 15, wherein the PUSCH layer aggregation level is determined based on the MIMO rank and the sub-aggregation indication.

17. The WTRU of claim 10, wherein the PUSCH layer aggregation level is further based on an interference level.

18. The WTRU of claim 17, wherein the interference level is related to a RADAR signal.
